(19) United States
(12) Patent Application Publication
(10) Pub. No.: US 2026/0246302 A1
(43) Pub. Date: Aug. 20, 2026

(54) POWER SUPPLY SYSTEM

(71) Applicant: TOYODA GOSEI CO., LTD., Kiyosu-shi (JP)

(72) Inventors: Seigi SHIMIZU, Kiyosu-shi (JP); Shoma SUZUKI, Kiyosu-shi (JP); Shinichiro FUKI, Kiyosu-shi (JP)

(21) Appl. No.: 19/437,786

(22) Filed: Dec. 31, 2025

(30) Foreign Application Priority Data
Feb. 18, 2025 (JP) 2025-024504

(51) Int. Cl. H02J 50/20; H01Q 21/06; H02J 50/90

(52) U.S. Cl. CPC H02J 50/20; H01Q 21/065; H02J 50/90

(57) ABSTRACT

A power supply system includes a power receiving device that includes a search signal receiving unit receiving a search signal, and a response signal output unit outputting a response signal as a response to reception of the search signal, and a power transmitting device that includes a power transmitting-side antenna unit outputting a power transmission signal, a search unit outputting the search signal to a predetermined power transmission range in which power transmission can be performed with high efficiency, a response signal receiving unit receiving the response signal, and a power transmitting-side control unit that controls the power transmitting-side antenna unit based on the received response signal to transmit the power transmission signal to the power transmission range.

### CROSS-REFERENCE TO RELATED APPLICATIONS

The present patent application claims the priority of Japanese patent application No. 2025/024504 filed on Feb. 18, 2025, and the entire contents of Japanese patent application No. 2025/024504 are hereby incorporated by reference.

### TECHNICAL FIELD

The present invention relates to a power supply system.

### BACKGROUND ART

A wireless power transmission system is known which includes a power receiver that outputs a beacon signal, and a power transmitter that outputs microwave energy toward the power receiver in response to the received beacon signal (see, e.g., Patent Literature 1).

In the wireless power transmission system, the power transmitter constantly focuses the microwave energy to the power receiver based on the reception of the beacon signal.

### CITATION LIST

### Patent Literatures

Patent Literature 1: JP 2020/058233A

### SUMMARY OF INVENTION

In the known wireless power transmission system, depending on the distance and angle between the power transmitter and the power receiver, the power receiver may not be in a state capable of receiving sufficient microwave energy even when the beacon signal reaches the power transmitter. In the known wireless power transmission system, power may be continuously transmitted in such a state since the beacon signal is kept being constantly output even though the power receiver can receive only small power, causing a problem of energy loss.

It is an object of the invention to provide a power supply system that suppresses energy loss due to power transmission.

An aspect of the invention provides a power supply system, comprising:

a power receiving device that comprises a search signal receiving unit receiving a search signal, and a response signal output unit outputting a response signal as a response to reception of the search signal, and

a power transmitting device that comprises a power transmitting-side antenna unit outputting a power transmission signal, a search unit outputting the search signal to a predetermined power transmission range in which power transmission can be performed with high efficiency, a response signal receiving unit receiving the response signal, and a power transmitting-side control unit that controls the power transmitting-side antenna unit based on the received response signal to transmit the power transmission signal to the power transmission range.

### ADVANTAGEOUS EFFECTS OF INVENTION

According to the invention, energy loss due to power transmission can be suppressed.

### BRIEF DESCRIPTION OF DRAWINGS

FIG. 1 is a diagram illustrating an example of a power supply system in a first embodiment.

FIG. 2 is an example block diagram explaining the power supply system in the first embodiment.

FIG. 3 is a diagram illustrating an example of a power transmission range of the power supply system in the first embodiment.

FIG. 4A is an explanatory diagram illustrating an example arrangement of a power receiving-side antenna unit and a substrate in a power receiving device of the first embodiment.

FIG. 4B is a diagram illustrating an example arrangement of the power receiving-side antenna unit, etc., on the front face of the power receiving device.

FIG. 5 is a flowchart showing an example operation of a power transmitting device in the first embodiment.

FIG. 6 is a flowchart showing an example operation of the power receiving device in the first embodiment.

FIG. 7A is a diagram illustrating an example of a power supply system in a second embodiment.

FIG. 7B is an example block diagram explaining a power transmitting device in the second embodiment.

FIG. 8 is a diagram illustrating an example arrangement of search signal receiving units in a third embodiment.

### DESCRIPTION OF EMBODIMENTS

### Summary of the embodiments

The power supply system in the embodiments is generally composed of a power receiving device that has a search signal receiving unit receiving a search signal, and a response signal output unit outputting a response signal as a response to reception of the search signal, and a power transmitting device that has a power transmitting-side antenna unit outputting a power transmission signal, a search unit outputting the search signal to a predetermined power transmission range in which power transmission can be performed with high efficiency, a response signal receiving unit receiving the response signal, and a power transmitting-side control unit that controls the power transmitting-side antenna unit based on the received response signal to transmit the power transmission signal to the power transmission range.

In this power supply system, power is transmitted only to power receiving devices which exist within the power transmission range where power transmission can be performed with high efficiency, and also have responded to the search signal. Therefore, energy loss due to power transmission can be suppressed compared to when this configuration is not adopted.

### First embodiment

### General Configuration of a Power Supply System 1

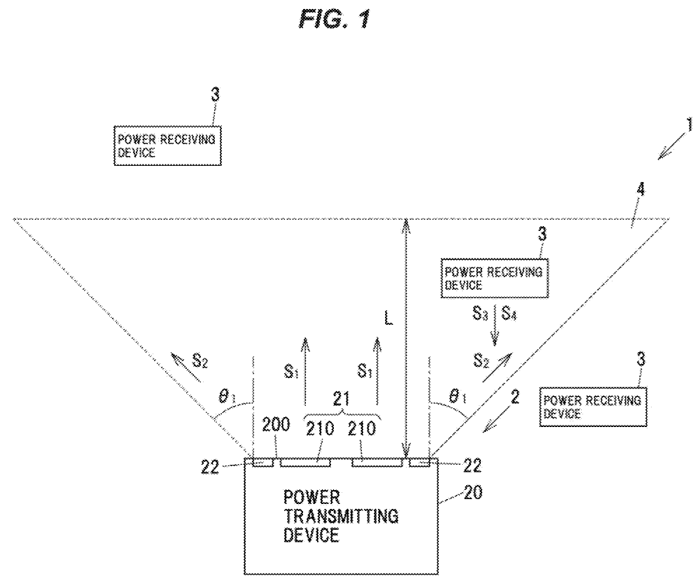

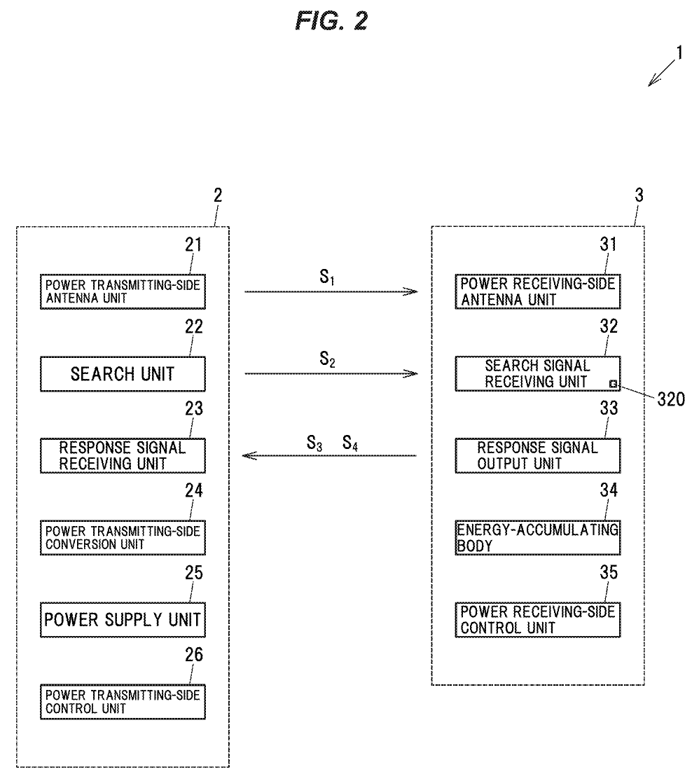

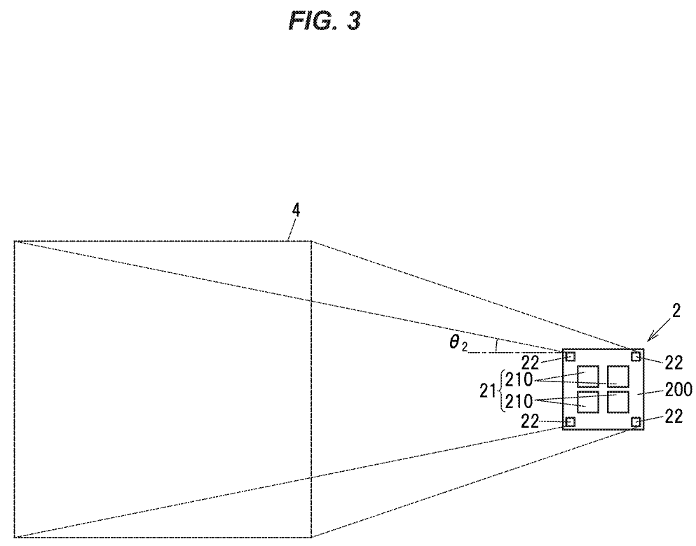

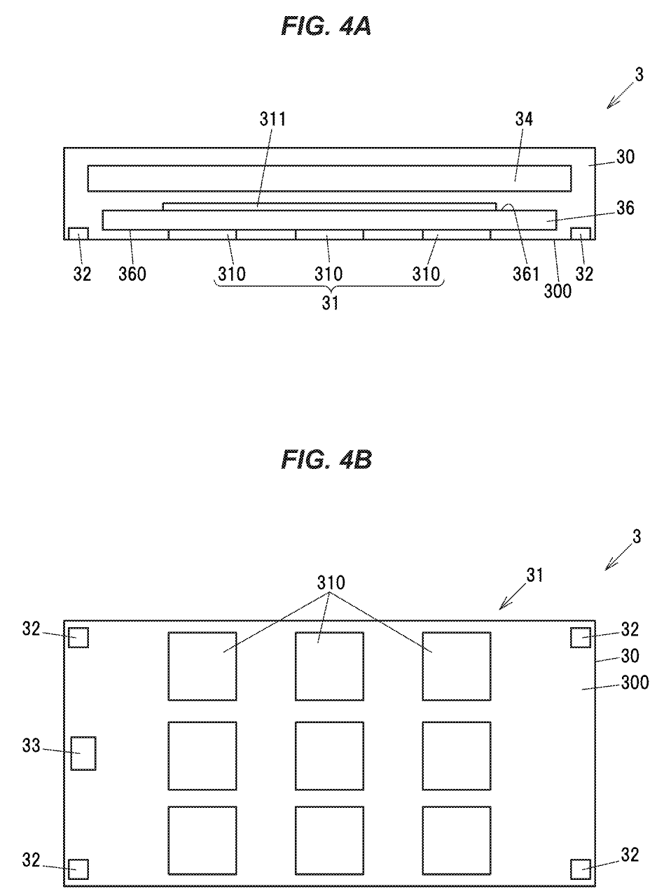

FIG. 1 is a diagram illustrating an example of a power supply system in the first embodiment. FIG. 2 is an example block diagram explaining the power supply system in the first embodiment. FIG. 3 is a diagram illustrating an example of a power transmission range of the power supply system in the first embodiment. FIG. 4A is an explanatory diagram illustrating an example arrangement of a power receiving-side antenna unit and a substrate in a power receiving device of the first embodiment, and FIG. 4B is a diagram illustrating an example arrangement of the power receiving-side antenna unit, etc., on the front face of the power receiving device.

In each drawing of the embodiments described below, a scale ratio or shape may be different between the drawings or different from an actual ratio or shape. In addition, in FIG. 2, flows of main signals and information are indicated by arrows. Furthermore, “A - B” indicating the numerical range shall be used to mean “not less than A and not more than B”. Next, the general configuration of the power supply system 1 will be described.

As shown in FIG. 1, the power supply system 1 is configured to transmit power toward a power transmission range 4 only when at least one power receiving device 3 exists within the power transmission range 4. Although three power receiving devices 3 are shown in FIG. 1, the number and positions of the power receiving devices 3 are merely an example and are not limited thereto.

As shown in FIGS. 1 and 2, the power supply system 1 is generally composed of a power receiving device 3 and a power transmitting device 2. The power receiving device 3 has a search signal receiving unit 32 receiving a search signal S₂, and a response signal output unit 33 outputting a response signal S₃ as a response to reception of the search signal S₂. The power transmitting device 2 has a power transmitting-side antenna unit 21 outputting a power transmission signal S₁, a search unit 22 outputting the search signal S₂ to a predetermined power transmission range 4 in which power transmission can be performed with high efficiency, a response signal receiving unit 23 receiving the response signal S₃, and a power transmitting-side control unit 26 that controls the power transmitting-side antenna unit 21 based on the received response signal S₃ to transmit the power transmission signal S₁ to the power transmission range 4.

The power transmission signal S₁ is a microwave having a frequency of 900 MHz to 60 GHz as an example but is not limited thereto. The response signal S₃ has a different frequency from the power transmission signal S₁.

The power transmitting-side control unit 26 stops transmission of the power transmission signal S₁ to the power receiving device 3 when the power receiving device 3, which was in the power transmission range 4, moves out of the power transmission range 4.

The power transmitting device 2 generally further includes a power transmitting-side conversion unit 24, and a power supply unit 25, as shown in FIG. 2.

The power receiving device 3 generally further includes a power receiving-side antenna unit 31, an energy-accumulating body 34, and a power receiving-side control unit 35, as shown in FIG. 2.

### Configuration of a Power Transmitting-Side Housing 20 of the Power Transmitting Device 2

As shown in FIGS. 1 and 3, the power transmitting-side housing 20 has a front face 200 on which the power transmitting-side antenna unit 21, the search units 22 and the response signal receiving unit 23 are arranged. The front face 200 is a flat surface, but is not limited thereto, and may be a curved surface, or a combination of a flat surface and a curved surface.

### Configuration of the Power Transmitting-Side Antenna Unit 21

The power transmitting-side antenna unit 21 outputs the power transmission signal S₁ toward the power transmission range 4. The power transmitting-side antenna unit 21 has four antennas 210 as an example, but is not limited thereto. As shown in FIG. 3, the antennas 210 have a rectangular shape and are arranged in a grid pattern as an example, but are not limited thereto.

### Configuration of the Search Unit 22

As shown in FIG. 3, the search units 22 are arranged at the four corners of the front face 200 as an example, but are not limited thereto. The search unit 22 outputs the search signal S₂ toward the power transmission range 4. This search signal S₂ is, e.g., a weak radio signal such as a laser using infrared light having high straight-traveling property, etc., but is not limited thereto. In this regard, communication using the search signal S₂ and the response signal S₃ is one-way communication, not intercommunication such as when using a beacon signal.

The power receiving device 3 receives less power when, e.g., having a distance from the front face 200 even if located in front thereof, as shown in FIG. 1. The power receiving device 3 receives less power also when, e.g., the angle relative to the front face 200 is small even if located close to the front face 200, as shown in FIG. 1. That is, the range where the power transmitting device 2 can transmit power with high efficiency, i.e., the range with high power reception efficiency, is a range which is in front of the power transmitting-side antenna unit 21 within a distance L of several meters and also in which the angle relative to the front face 200 is not small. The power transmission range 4 is set in advance as such a range.

Therefore, the power transmission range 4 is mainly the range in front of the front face 200 of the power transmitting-side housing 20, as shown in FIGS. 1 and 3. In particular, as an example, the power transmission range 4 is a range angled to the left and right by an angle θ₁ and upward and downward by an angle θ₂ relative to the front face 200, with the distance L from the front face 200. That is, as shown in FIG. 3, the power transmission range 4 is a region surrounded by dotted lines and the front face 200 and has a shape obtained by cutting off the vicinity of the apex of a quadrangular pyramid by the front face 200, as an example.

The angles θ₁ and θ₂ are set taking into consideration the spread of the power transmission signal S₁. In addition, the angles θ₁ and θ₂ are the same angle as an example but are not limited thereto. Furthermore, the angles θ₁ and θ₂ are 45° as an example but are not limited thereto. The distance L is 5m as an example but is not limited thereto.

The search unit 22 may output the search signal S₂ to the power transmission range 4 even when a chargeable power receiving device 3 exists within the power transmission range 4 or may stop outputting the search signal S₂ at least until receiving a charging status signal S₄ indicating full charge from the power receiving device 3 located within the power transmission range 4. The search unit 22 in the first embodiment outputs the search signal S₂ even when a chargeable power receiving device 3 already exists within the power transmission range 4. Then, the power transmitting device 2, after transmitting the power transmission signal S₁ to the chargeable power receiving device 3 which already exists and when no longer receiving the response signal S₃, stops power transmission upon determination that the power receiving device 3 has moved out of the power transmission range 4.

### Configuration of the Response Signal Receiving Unit 23

The response signal receiving unit 23 is arranged on the front face 200. The response signal receiving unit 23 receives the response signal S₃ as a response to the reception of the search signal S₂. This response signal receiving unit 23 is configured to communicate with the response signal output unit 33 using, e.g., Bluetooth (registered trademark) which is a short-range wireless communication standard, but the configuration is not limited thereto.

The response signal S₃ is transmitted when the power receiving device 3 is in a chargeable state. This chargeable state refers to a condition where, e.g., the energy-accumulating body 34 is not fully charged, there are no malfunctions in a charging circuit, etc. and it is possible to perform charging.

### Configuration of the Power Transmitting-Side Conversion Unit 24

The power transmitting-side conversion unit 24 converts power of the power supply unit 25 into the power transmission signal S₁ which is a microwave.

### Configuration of the Power Supply Unit 25

The power supply unit 25 supplies power to be converted into the power transmission signal S₁. The power supply unit 25 may be configured to use power supplied from an external power source or may be configured as an energy-accumulating body.

### Configuration of the Power Transmitting-Side Control Unit 26

The power transmitting-side control unit 26 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The power transmitting-side control unit 26 is electrically connected to the power transmitting-side antenna unit 21, the search unit 22, the response signal receiving unit 23, the power transmitting-side conversion unit 24 and the power supply unit 25.

When the power receiving device 3 exists within the power transmission range 4, the power transmitting-side control unit 26 controls the power transmitting-side antenna unit 21, etc., to output the power transmission signal S₁ toward the power transmission range 4.

### Configuration of a Power Receiving-Side Housing 30 of the Power Receiving Device 3

As shown in FIGS. 4A and 4B, the power receiving-side housing 30 has a front face 300 on which the power receiving-side antenna unit 31, the search signal receiving units 32 and the response signal output unit 33 are arranged. The front face 300 is a flat surface, but is not limited thereto, and may be a curved surface, or a combination of a flat surface and a curved surface.

### Configuration of the Power Receiving-Side Antenna Unit 31

The power receiving-side antenna unit 31 has nine antennas 310 as shown in FIG. 4B, but is not limited thereto. The antennas 310 are arranged in a grid pattern.

As shown in FIG. 4A, the power receiving-side antenna unit 31 is a rectenna (rectifying antenna) including a rectifier circuit 311, etc. This power receiving-side antenna unit 31 has antennas 310 mounted on a front surface 360 of a control board 36, and the rectifier circuit, etc. mounted on a back surface 361 of the control board 36. Since the antennas 310 and the rectifier circuit 311 can be connected at a short distance in the power receiving-side antenna unit 31, losses when converting high-frequency AC power into DC power can be suppressed.

In the power receiving device 3, the search signal receiving units 32 are arranged around the power receiving-side antenna unit 31. Therefore, the power receiving device 3 does not require that the entire portion of the power receiving-side housing 30 is located within the power transmission range 4, as long as any of the search signal receiving units 32 receives the search signal S₂, i.e., at least one search signal receiving unit 32 is located within the power transmission range 4. This is because power reception efficiency is still high in the area around the power transmission range 4 even though it is not as high as in the middle of the power transmission range 4. In this case, even when only one search signal receiving unit 32 is located within the power transmission range 4, the power receiving device 3 can receive the power transmission signal S₁ with high efficiency since the antennas 310 are located nearby.

### Configuration of the Search Signal Receiving Unit 32

The search signal receiving units 32 are arranged at the four corners of the front face 300 as an example but are not limited thereto. The search signal receiving units 32 receive the search signal S₂ output from the power transmitting device 2.

The search signal receiving unit 32 has, e.g., a threshold value 320. When the intensity of the received search signal S₂ is not less than the threshold value 320, the search signal receiving unit 32 causes the response signal output unit 33 to output the response signal S₃. At locations where the intensity of the received search signal S₂ is low, there is a high possibility that the intensity of the power transmission signal S₁ which is receivable is also low. Therefore, the search signal receiving unit 32 can suppress a situation where the response signal S₃ is output even though the intensity of the receive search signal S₂ is low.

### Configuration of the Response Signal Output Unit 33

The response signal output unit 33 outputs the response signal S₃ indicating that the search signal receiving unit 32 has received the search signal S₂. In this regard, the response signal S₃ may include information about the intensity of the received search signal S₂.

The response signal output unit 33 also outputs the charging status signal S₄ indicating a charging status of the energy-accumulating body 34. This charging status signal S₄ indicates, e.g., at least whether or not the energy-accumulating body 34 is fully charged. The power transmitting-side control unit 26, when acquired the charging status signal S₄ indicating full charge, stops outputting the power transmission signal S₁. In this regard, to suppress situations where the power transmission signal S₁ is output in spite of being fully charged, it is determined that it is fully charged when reaching 90 to 95% of the charging capacity, but the configuration is not limited thereto. In addition, the charging status signal S₄ is constantly output, but may be configured to be output constantly once the charge level becomes closed to full for the same reason, but the configuration is not limited thereto.

### Configuration of the Energy-Accumulating Body 34

The energy-accumulating body 34 is, e.g., a rechargeable battery such as a lithium-ion battery, a nickel-metal hydride battery, or a nickel-cadmium battery. This energy-accumulating body 34 is charged with power which is obtained based on the power transmission signal S₁ transmitted from the power transmitting device 2.

### Configuration of the Power Receiving-Side Control Unit 35

The power receiving-side control unit 35 is, e.g., a microcomputer composed of a CPU, a RAM, and a ROM, etc. The power receiving-side control unit 35 is electrically connected to the power receiving-side antenna unit 31, the search signal receiving unit 32, the response signal output unit 33 and the energy-accumulating body 34. This power receiving-side control unit 35 is arranged on, e.g., the back surface 361 of the control board 36 and is electrically connected to the rectifier circuit 311 at a short distance.

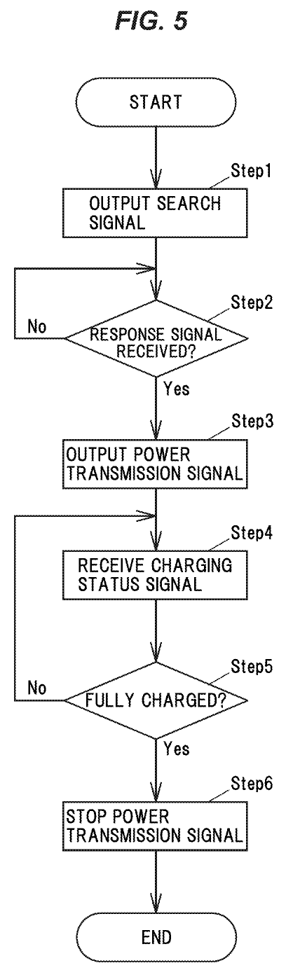

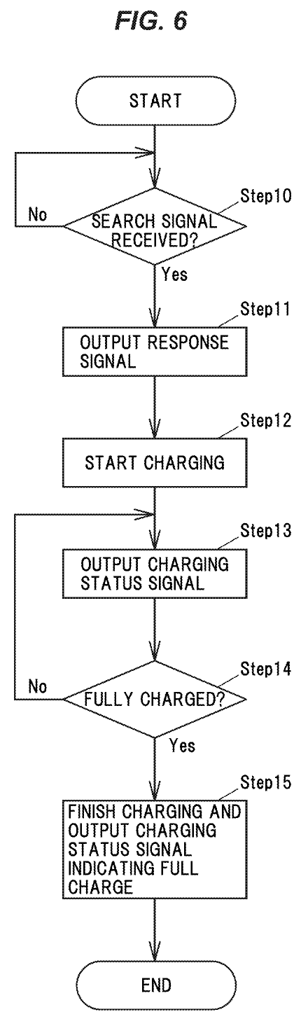

Next, example operations of the power transmitting device 2 and the power receiving device 3 of the power supply system 1 in the first embodiment will be described with reference to the flowcharts of FIGS. 5 and 6.

### Operation of the Power Transmitting Device 2

The power transmitting-side control unit 26 of the power transmitting device 2 controls the search unit 22 to output the search signal S₂ to the power transmission range 4 (Step 1).

When it is “Yes” in Step 2 (Step 2: Yes), i.e., when the response signal receiving unit 23 receives the response signal S₃ output from the power receiving device 3, the power transmitting-side control unit 26 outputs the power transmission signal S₁ to the power transmission range 4 (Step 3).

Once receiving the charging status signal S₄ output from the power receiving device 3 and input through the response signal receiving unit 23, the power transmitting-side control unit 26 checks the charging status (Step 4).

When it is determined that the energy-accumulating body 34 of the power receiving device 3 is fully charged based on the charging status signal S₄ (Step 5: Yes), the power transmitting-side control unit 26 stops outputting the power transmission signal S₁ (Step 6) and ends the power transmission operation. In this regard, when plural power receiving devices 3 exist within the power transmission range 4, the power transmitting-side control unit 26 continuously outputs the power transmission signal S₁ as long as at least one power receiving device 3 is in a chargeable state.

Here, when the power transmitting-side control unit 26 determines in Step 5 that the energy-accumulating body 34 of the power receiving device 3 is not fully charged based on the charging status signal S₄ (Step 5: No), the process proceeds to Step 4.

### Operation of the Power Receiving Device 3

When it is “Yes” in Step 10 (Step 10: Yes), the power receiving-side control unit 35 of the power receiving device 3 controls the response signal output unit 33 to output the response signal S₃ (Step 11). This response signal S₃ is output when the energy-accumulating body 34 is in a chargeable state, as described above.

The power receiving-side control unit 35, when received the power transmission signal S₁ through the power receiving-side antenna unit 31, starts charging the energy-accumulating body 34 (Step 12).

The power receiving-side control unit 35 outputs the charging status signal S₄ indicating the charging status of the energy-accumulating body 34 through the response signal output unit 33 (Step 13). This charging status signal S₄ is output according to the acquired charging capacity of the energy-accumulating body 34.

When the energy-accumulating body 34 is fully charged (Step 14: Yes), the power receiving-side control unit 35 finishes charging and also outputs the charging status signal S₄ indicating full charge through the response signal output unit 33 (Step 15), and ends the charging operation.

Here, when the energy-accumulating body 34 is not fully charged in Step 14 (step 14: No), the power receiving-side control unit 35 proceeds the process to Step 13 to output the charging status signal S₄ indicating that it is not fully charged.

### Effects of the First Embodiment

The power supply system 1 in the first embodiment can suppress energy loss due to power transmission. In particular, in the power supply system 1, power is transmitted only to power receiving devices 3 which exist within the power transmission range 4 and also have responded to the search signal S₂. Therefore, energy loss due to power transmission can be suppressed compared to the case where a beacon signal is constantly output even though the power receiving device is located in a range with low power transmission efficiency.

In the power supply system 1, power is transmitted only to power receiving devices 3 which exist within the power transmission range 4, have responded to the search signal S₂ and are also in a state capable of receiving power. Therefore, compared to when this configuration is not adopted, it is possible to suppress power transmission in a state of low power reception efficiency and power transmission in a state in which charging is not possible, thereby suppressing unnecessary power consumption of the power transmitting device 2.

In the power supply system 1, the power receiving device 3 does not need to constantly output intercommunication signals such as beacon signals. Therefore, power consumption of the power receiving device 3 can be suppressed.

In the power supply system 1, power is transmitted only when the power receiving device 3 exists within the power transmission range 4 in which the power reception efficiency is high. Therefore, unnecessary power consumption can be suppressed compared to when continuously transmitting power to the power receiving device located in a position where power reception efficiency is low.

In the power supply system 1, power is transmitted based on the reception of the response signal S₃ output in response to the search signal S₂. Therefore, power consumption of the power transmitting device 2 can be suppressed compared to when measuring the distance to the power receiving device or changing the phase of the power transmission signal.

### Second Embodiment

The second embodiment differs from the first embodiment in that a peripheral range is provided outside the power transmission range.

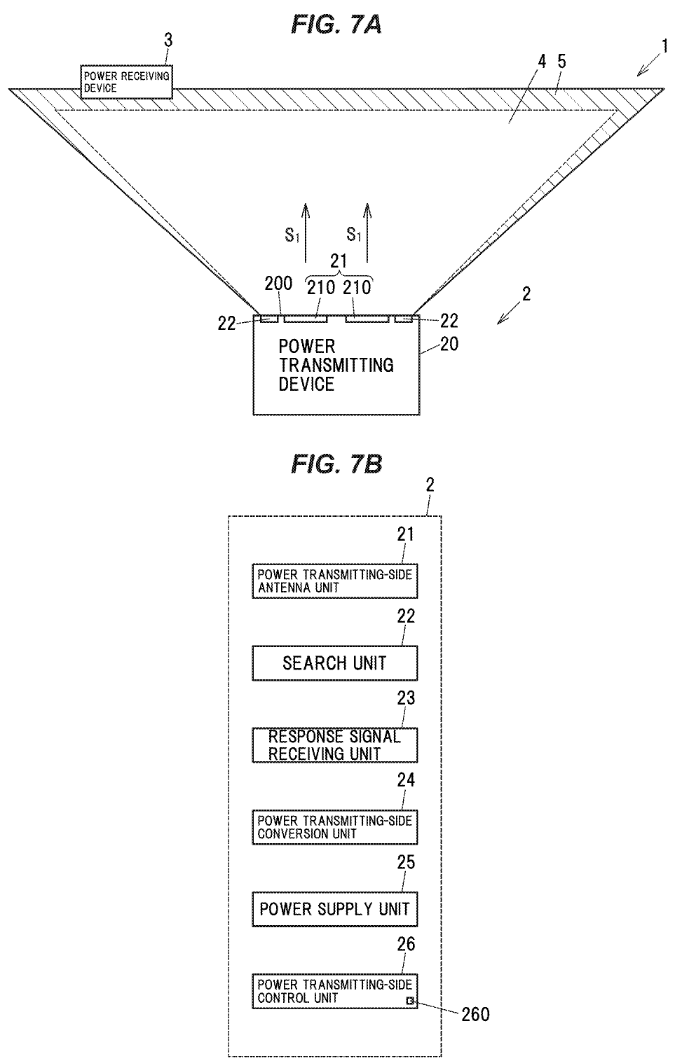

FIG. 7A is a diagram illustrating an example of a power supply system in the second embodiment, and FIG. 7B is an example block diagram explaining the power transmitting device in the second embodiment. In the embodiments described below, portions having the same functions and configurations as those in the first embodiment are denoted by the same reference signs as those in the first embodiment and the explanation thereof will be omitted.

The power transmitting-side control unit 26 of the power transmitting device 2 is configured to set a peripheral range 5 outside the power transmission range 4 as shown in FIG. 7A and to output the power transmission signal S₁ when the power receiving device 3 exists within the peripheral range 5 based on the response signal S₃.

The area around the power transmission range 4 has high power reception efficiency even though it is not as high as the power transmission range 4. That is, the intensity of the power transmission signal S₁ does not drop sharply once passing beyond the power transmission range 4, but rather gradually weakens in a gradation manner as the distance from the power transmission range 4 increases. For this reason, in the second embodiment, the peripheral range 5 outwardly expanded from the power transmission range 4 is provided as indicated by shading in FIG. 7A. The peripheral range 5 is expanded forward, upward, downward, leftward and rightward from the power transmission range 4.

The power receiving device 3 in the second embodiment is configured to output the response signal S₃ including information about the intensity of the received search signal S₂.

The power transmitting-side control unit 26 has an intensity threshold value 260 as shown in FIG. 7B, and transmits the power transmission signal S₁ toward the power transmission range 4 when the intensity of the search signal S₂ received by the power receiving device 3 is not less than the intensity threshold value 260. As a modification, when the power receiving device 3 is located within the peripheral range 5, the power transmitting-side control unit 26 may transmit the power transmission signal S₁ with an increased intensity. Furthermore, the power supply system 1 may be configured such that a range expanded from the power transmission range 4 is divided into plural ranges and the intensity of the power transmission signal S₁ is changed for each range.

### Effect of the Second Embodiment

When determination is made based on whether or not located within the power transmission range 4, power is not transmitted to the power receiving device 3 shown in FIG. 7A since it is not located within the power transmission range 4. However, the power transmitting device 2 in the second embodiment transmits the power transmission signal S₁ also to the power receiving device 3 located in the peripheral range 5. Therefore, compared to when this configuration is not adopted, the conditions for starting power transmission are eased, which makes charging easier.

### Third Embodiment

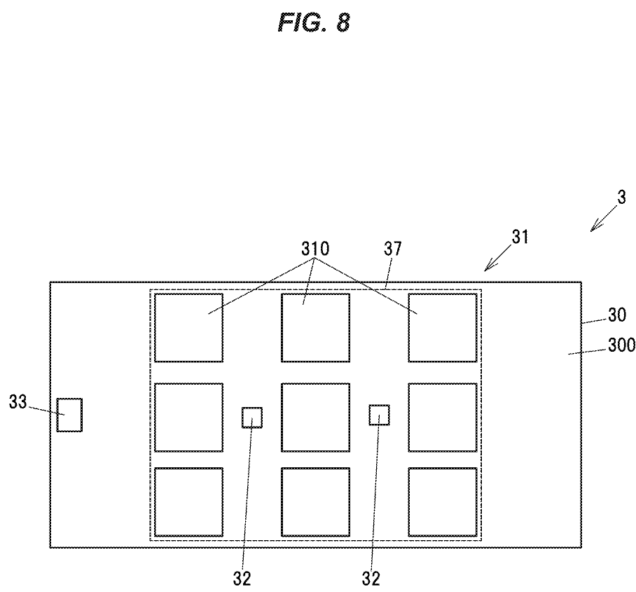

The third embodiment differs from the other embodiments in that the search signal receiving units are provided within an antenna region. FIG. 8 is a diagram illustrating an example arrangement of the search signal receiving units in the third embodiment.

The power receiving device 3 has the power receiving-side antenna unit 31 that receives the power transmission signal S₁, as shown in FIG. 8. The search signal receiving units 32 are arranged in an antenna region 37 defined by the power receiving-side antenna unit 31.

The antenna region 37 is a region that includes plural antennas 310, as indicated by a dotted line in FIG. 8. The plural antennas 310 receive the power transmission signal S₁ and are thus preferably located within the power transmission range 4.

The search signal receiving units 32 are arranged in the antenna region 37 so as to sandwich the central antenna 310 as shown in FIG. 8, but the number and positions of the search signal receiving units 32 are not limited thereto. Arranging the search signal receiving units 32 so as to sandwich the central antenna 310 increases the possibility of including many antennas 310 in the power transmission range 4 at the position where the search signal S₂ is received.

### Effects of the Third Embodiment

In the power supply system 1 of the third embodiment, the search signal receiving units 32 are arranged in the antenna region 37. Therefore, compared to when this configuration is not adopted, the location where the search signal S₂ is received is more likely to be within the power transmission range 4, and power transmission can be performed with higher efficiency.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention. In addition, not all combinations of the features described in the embodiments and modifications are necessary to solve the problem of the invention. Further, these embodiments and modifications are included within the scope and gist of the invention and also within the invention described in the claims and the range of equivalency.

### REFERENCE SIGNS LIST

1 Power Supply System
2 Power Transmitting Device
3 Power Receiving Device
4 Power Transmission Range
5 Peripheral Range
20 Power Transmitting-Side Housing
21 Power Transmitting-Side Antenna Unit
22 Search Unit
23 Response Signal Receiving Unit
24 Power Transmitting-Side Conversion Unit
25 Power Supply Unit
26 Power Transmitting-Side Control Unit
30 Power Receiving-Side Housing
31 Power Receiving-Side Antenna Unit
32 Search Signal Receiving Unit
33 Response Signal Output Unit
34 Energy-Accumulating Body
35 Power Receiving-Side Control Unit
36 Control Board
37 Antenna Region
200 Front Face
210 Antenna
260 Intensity Threshold Value
300 Front Face
310 Antenna
311 Rectifier Circuit
320 Threshold Value
360 Front Surface
361 Back Surface

1. A power supply system, comprising:
a power receiving device that comprises a search signal receiving unit receiving a search signal, and a response signal output unit outputting a response signal as a response to reception of the search signal, and
a power transmitting device that comprises a power transmitting-side antenna unit outputting a power transmission signal, a search unit outputting the search signal to a predetermined power transmission range in which power transmission can be performed with high efficiency, a response signal receiving unit receiving the response signal, and a power transmitting-side control unit that controls the power transmitting-side antenna unit based on the received response signal to transmit the power transmission signal to the power transmission range.

2. The power supply system according to claim 1, wherein the power transmitting-side control unit sets a peripheral range outside the power transmission range, and outputs the power transmission signal when the power receiving device exists within the peripheral range based on the response signal.

3. The power supply system according to claim 1, wherein the power transmitting-side control unit stops transmission of the power transmission signal to the power receiving device when the power receiving device, which was in the power transmission range, moves out of the power transmission range.

4. The power supply system according to claim 1, wherein the power receiving device comprises a power receiving-side antenna unit that receives the power transmission signal, and wherein the search signal receiving unit is arranged in an antenna region defined by the power receiving-side antenna unit.
